(19) United States
(12) Patent Application Publication
(10) Pub. No.: US 2008/0151806 A1
(43) Pub. Date: Jun. 26, 2008

(54) FLEXIBLE RADIO NETWORK

(75) Inventors: Philippe Bereski, Morsang Sur Orge (FR); Antoine Soulie, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/961,981

(22) Filed: Dec. 20, 2007

(30) Foreign Application Priority Data
Dec. 22, 2006 (FR) 0655893

(51) Int. Cl. H04H 20/71

(52) U.S. Cl. 370/312

(57) ABSTRACT

A telecommunication node (1), comprises a local base station (3) capable of emitting beacon signals so as to be detected by adjacent radio terminals, a local radio terminal (4) with means for detecting beacon signals to detect a base station adjacent to said local radio terminal, and radio link management means to enable setting up of a radio link (2) between said communication node and at least a remote communication node including at least an element chosen among the group consisting of a base station adjacent to said local radio terminal and a radio terminal adjacent to said local base station. A radio receiver is capable of receiving configuration data defining air support resources to be allocated to a local base station on a low speed radio channel.

The invention relates to the domain of radio telecommunication networks, and particularly high speed point to multipoint networks.

In a point to multipoint radio system, a central emitter that will be called the base station is capable of establishing radio links with several receivers that will be called radio terminals located in a coverage zone also called cell. Links may be one directional or two directional. A multiplexing method is used to multiplex these links on the air support. Known multiplexing methods include particularly TDMA, FDMA, CSMA, CDMA and OFDMA. The multiplexing method may be the same in the up direction and in the down direction, or it may be different. Many developments have been made to point-to-multipoint radio networks tending to increase communication speeds, as shown by the development of the 2G, EDGE, 3G, HSDPA, HSUPA, WI-FI, WIMAX technologies. This change is motivated by a number of reasons including the desire to make voice, data and video networks converge (triple play).

U.S. Pat. No. 20020167954 discloses a consecutive point to multipoint type network (CPMP) architecture in which the base stations and the radio terminals are arranged so as to form both an integrated point to multipoint access network and an integrated core network. This document describes cellular networks with fixed infrastructure.

There is a need in specific applications for flexible networks that are easy to deploy and to reconfigure, particularly for field operations related to first aid, security or defense, for example on a zone with no telecommunication infrastructure. The maximum speeds of radio technologies available for these applications at the moment are significantly less than for the above-mentioned radio networks. For example, VHF type radios have data throughputs of the order of 10 to 100 kb/s.

Therefore, there is a need for high speed radio telecommunication networks with some functional flexibility. Functional flexibility means a set of characteristics including the ability to easily accept a new communication node in the network, the ability to adapt to deactivation or disappearance of a node from the network, the ability to accept mobility of base stations and more generally any characteristic that facilitates deployment or redeployment of the network. There is also a need for a flexible high speed network capable of guaranteeing service quality levels. The purpose of the invention is to satisfy at least some of these needs.

To achieve this, the invention discloses a telecommunication node comprising at least one local base station capable of using a multiple access method to set up point to multipoint radio links with radio terminals, at least one local radio terminal capable of using said multiple access method to set up a radio link with a base station, and a switch to transfer data between said local radio terminal and said local base station.

According to a preferred embodiment, the local base station is capable of emitting beacon signals for it to be detected by adjacent radio terminals, the local radio terminal comprises means of detecting beacon signals to detect a base station adjacent to said local radio terminal, and the communication node comprises means of managing radio links to inhibit setting up redundant radio links implying said at least one local radio terminal and/or said at least one local base station.

The terms “local base station” and “local radio terminal” denote one (or several) base station(s) and one (or several) radio terminal(s) that have a link other than the air interface to exchange data between themselves, particularly through a local network provided with a switch or router. The term “remote communication node” means a node that does not have any link other than the air interface to exchange data with the local radio terminal or the local base station. The term “adjacent” in this description denotes a physical situation used to set up a radio communication between a base station and a radio terminal, considering the characteristics of the radio interfaces of this equipment and environmental parameters that may have an influence on the range of radio links. According to the invention, a radio link may be redundant with regard to another radio link or with regard to the local network of a node.

According to other advantageous embodiments, the communication node may have one or several of the following characteristics:
the radio link management means can inhibit a radio link set up between said local radio terminal or each local radio terminal and said local base station or each local base station. This measure has two advantages, firstly it leaves a greater pass band available on the local base station to set up links with remote radio terminals, and it allows the local radio terminal to set up a link with a remote base station. Therefore it facilitates connectivity of the node.
radio link management means are capable of configuring means of detecting a local radio terminal such that said detection means monitor part of the spectrum excluding one or each frequency on which a local base station emits beacon signals.
it comprises a plurality of local radio terminals, said radio link management means being capable of detecting that a radio link is set up between a first of said local radio terminals and a base station and inhibiting setting up of a radio link between a second of said local radio terminals and said base station in response to said detection.
the radio link management means are capable of detecting that a radio link is set up between said local base station and a first radio terminal of a remote node and inhibiting setting up of a radio link between said local base station and a second radio terminal of said remote node in response to said detection.
it comprises a plurality of local base stations, the radio link management means being capable of detecting that a radio link is set up between a first of said local base stations and a remote node and inhibiting a radio link from being set up between a second of said local base stations and said remote node in response to said detection.
inhibition of these links may take place at different levels, for example at a physical level by measures such as selection or restriction of frequencies that can be used by a radio terminal, or at a logical level by measures such as selection or restriction of logical identifiers acceptable by a radio terminal or a base station.
the local base station or each local base station is capable of reserving and allocating air support resources to determined communications. Reservation of resources provides a means of guaranteeing a predefined service quality in communications with radio terminals. Depending on the different embodiments, a base station may use reservations and allocations of air support resources with different granularity levels, for example the radio terminal level, the dataflow level, the service class level (for example for a “best effort” class), etc. Air support resources may be shared in multiple forms depending on the multiplexing techniques used, for example in the form of time intervals using a TDMA technique, frequency intervals using an SDMA technique, spectrum spreading codes in a CDMA technique, a combination of time and frequency intervals in an OFDMA technique, and other combinations.
it comprises a radio receiver to receive configuration data defining air support resources to be allocated to a local base station on a low speed radio channel, and a configuration module to configure said local base station so as to respect said allocated air support resources. Thus, the air support resources may be allocated remotely to the base station of a node, for example from a network management system, so as to satisfy an orthogonality condition or a non-interference condition with other base stations in the network.
it comprises a radio receiver to receive configuration data defining an activity state of a local base station on a low speed radio channel, and a configuration module to activate or deactivate said local base station as a function of said configuration data. Thus, the base station of a node may be remotely activated or deactivated, for example from a network management system, which facilitates reconfiguration of the radio network.

Such a telecommunication node may be made in the form of a unit equipment, preferably relatively compact, which facilitates transport and installation operations. An energy generation system could possibly be integrated into the node to make it self-sufficient, for example with batteries and a solar generator or a thermal combustion engine. According to one particular embodiment, the telecommunication node is installed on a land vehicle or a ship.

The invention also discloses a radio network comprising a plurality of telecommunication nodes, characterised by the fact that it comprises a central or distributed management system to define sharing of air support resources between base stations of said telecommunication nodes, and a radio transmitter capable of transmitting configuration data on said low speed radio channel defining air support resources to be allocated to each of said base stations, as a function of said sharing.

The invention also provides a method for management of radio links in a radio telecommunication network comprising steps consisting of:

emitting beacon signals from a base station, detecting beacon signals at a radio terminal, determining if the radio terminal and the base station belong to the same node in said network, and inhibiting setting up of a radio link between the radio terminal and the base station when they belong to the same node of said network. The inhibiting step may be in the form of a measure interrupting the radio attachment procedure between the radio terminal and the base station. Such an interruption may be done at different levels of the attachment procedure.

The invention also discloses a method of configuring a telecommunication node, comprising steps consisting of:

deploying at least one radio telecommunication node comprising at least one local base station that can use a multiple access method to set up point to multipoint radio links with radio terminals, or at least one local radio terminal capable of using said multiple access method to set up a radio link with a base station, and a switch to transfer data between said local radio terminal and said local base station,

transmitting configuration data defining air support resources to be allocated to said local base station, on at least one low speed long range radio channel,

receiving said configuration data at said telecommunication node and configuring said local base station so as to respect said allocated air support resources.

Preferably, this method also comprises a step consisting of producing said configuration data as a function of a position of said telecommunication node or as a function of quality measurements of base station signals. For example, these measures may be provided by a radio terminal located in an overlap zone of cells of two base stations that produce mutual interferences. Such a situation may thus be the event triggering reconfiguration of a base station.

The invention also provides a method of configuring a telecommunication node, comprising steps consisting of deploying at least one radio telecommunication node comprising at least one local base station capable of using a multiplexing method to set up point to multipoint radio links with radio terminals, at least one local radio terminal capable of using said multiplexing method to set a radio link with a base station, and a switch to transfer data between said local radio terminal and said local base station, transmitting configuration data on a low speed long range radio channel, designating a base station, receiving said configuration data at said telecommunication node and configuring a said local radio terminal to attempt to set up a radio link with said designated base station.

The invention also provides a network management system that can be used to configure base stations or radio terminals using these methods.

One concept on which the invention is based is to form a telecommunication node using high speed point to multipoint technologies capable of making radio links between pairs to form a meshed or ad hoc network. Another concept on which the invention is based is to use a dedicated signaling channel, particularly using low speed radio systems available on the market, to configure or reconfigure network nodes remotely, so as to facilitate network deployment or redeployment. Another concept on which the invention is based is to produce automated radio attachment procedures between nodes that optimise the global connectivity of the network and its reconfigurability. Yet another concept on which the invention is based is to give priority to setting up a radio link between the communication node and at least one remote communication node including at least one element chosen from the group consisting of a base station adjacent to said local radio terminal and a radio terminal adjacent to said local base station, so as to form a strongly meshed network.

The invention will be better understood and other purposes, details, characteristics and advantages of it will become clearer after reading the following description of several particular embodiments of the invention, given solely for illustrative and non-limitative purposes with reference to the appended drawings. On these drawings:

FIG. 1 shows a functional diagrammatic representation of a flexible radio network according to a first embodiment of the invention,

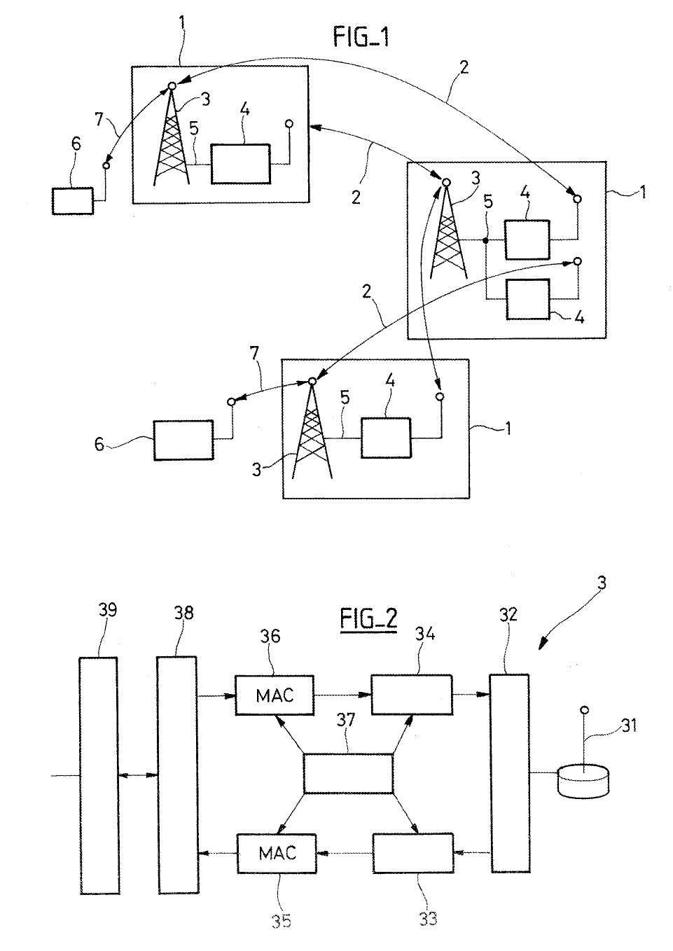

FIG. 2 shows a functional diagrammatic representation of a base station that can be used in the network in FIG. 1,

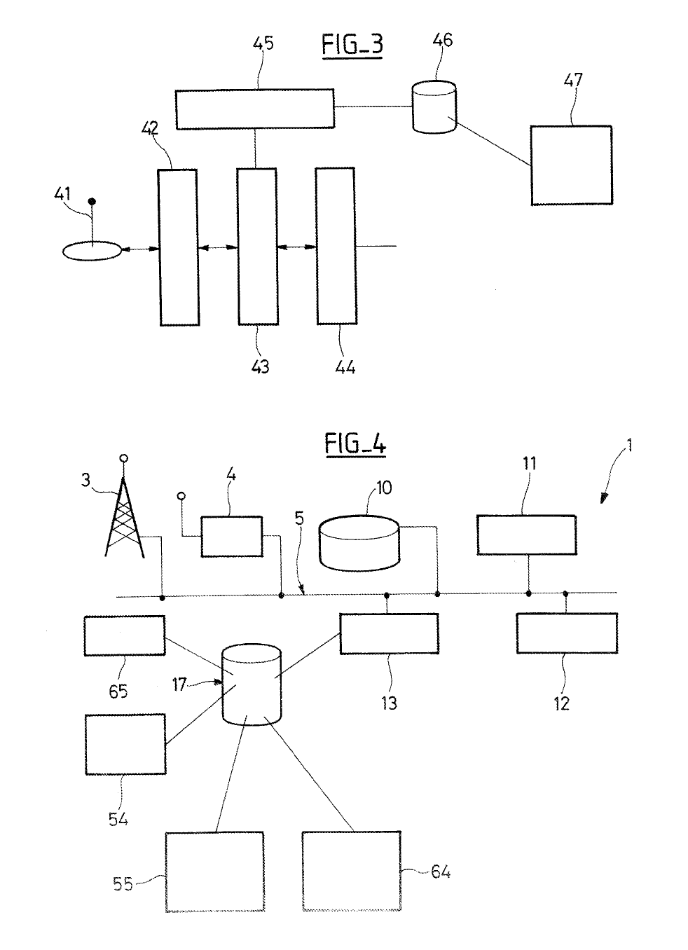

FIG. 3 shows a functional diagrammatic representation of a radio terminal that can be used in the network in FIG. 1,

FIG. 4 shows a functional diagrammatic representation of a telecommunication node that can be used in the network in FIG. 1,

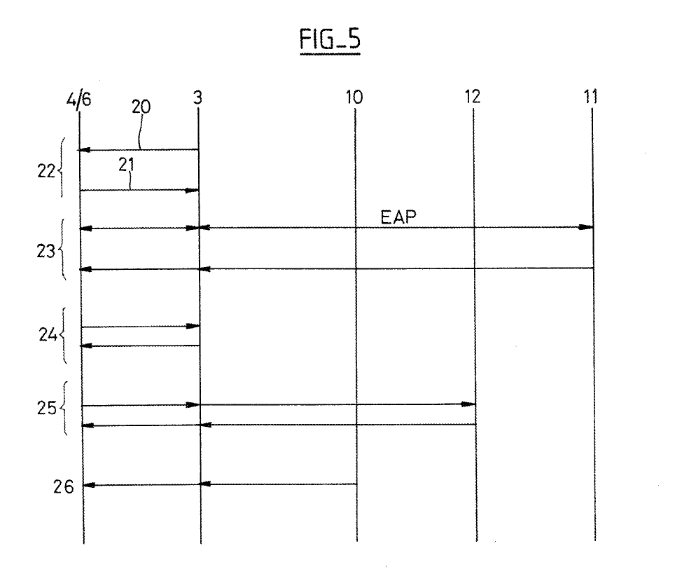

FIG. 5 shows a diagram representing a procedure for attachment of the radio that can be used in the network in FIG. 1,

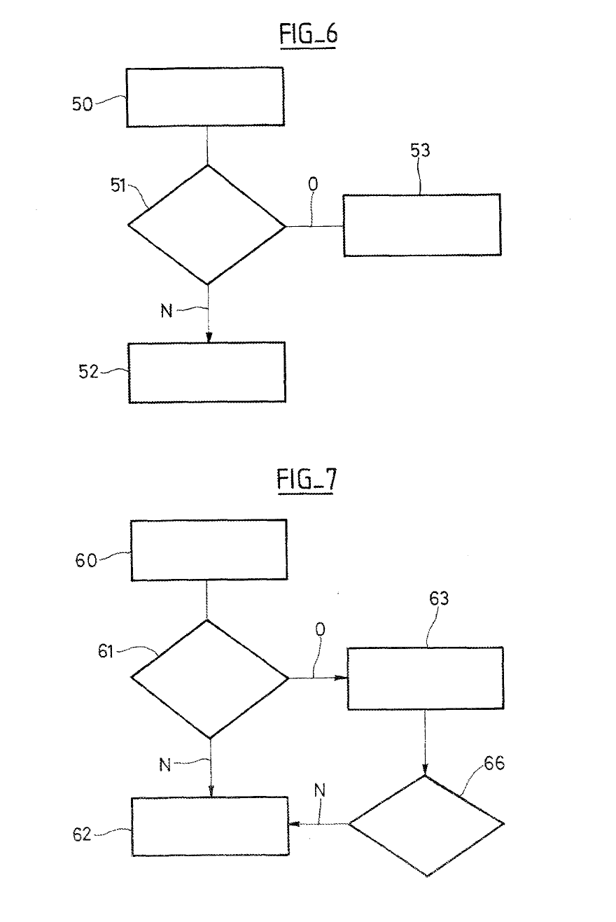

FIGS. 6 and 7 show a diagram representing methods of managing radio links that can be used in the network in FIG. 1,

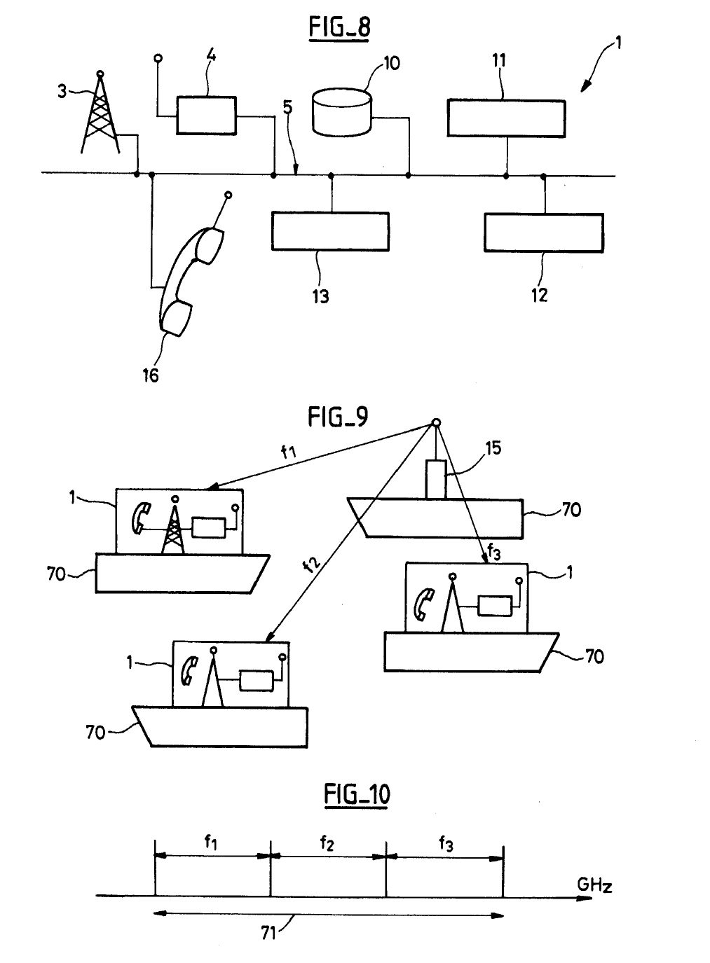

FIG. 8 shows a functional diagrammatic representation of telecommunication node according to another embodiment of the invention,

FIG. 9 shows a functional diagrammatic representation of a flexible radio network comprising a management system,

FIG. 10 shows a diagram representing spectrum sharing that can be used in the network in FIG. 9,

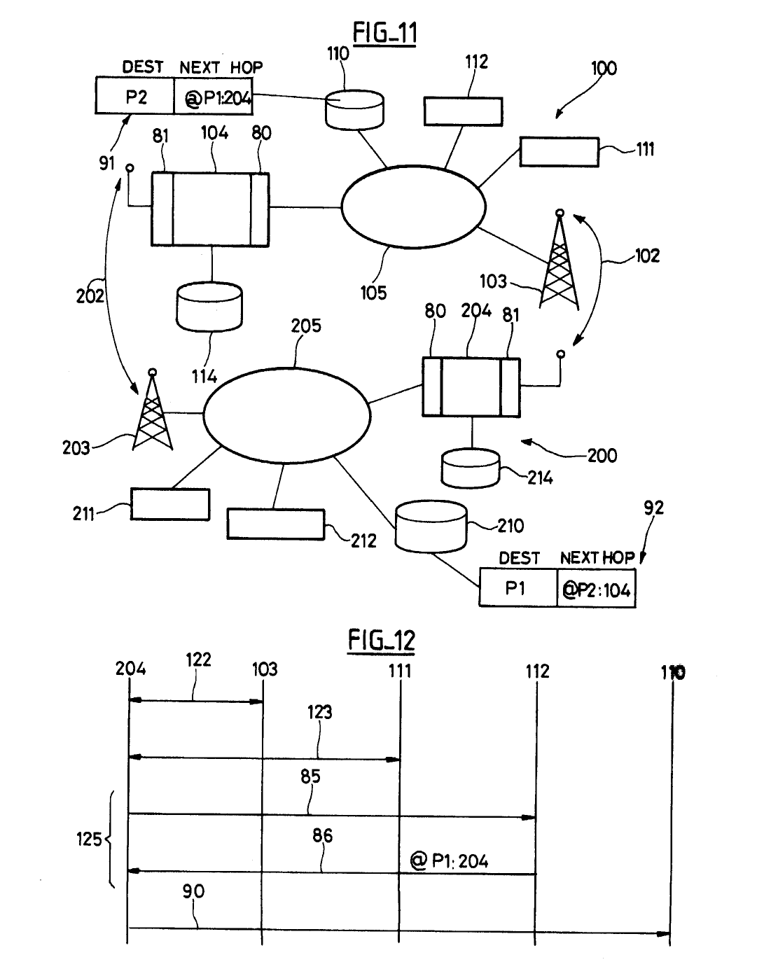

FIG. 11 shows a functional diagrammatic representation of a flexible radio network according to another embodiment of the invention,

FIG. 12 shows a diagram representing an IP configuration procedure that can be used in the network in FIG. 11.

FIG. 1 shows a radio network comprising several nodes 1 connected to each other through two-directional point to multipoint type radio links 2. Each time, a node 1 comprises one or several local base stations 3 and one or several local radio terminals 4, together with a LAN 5 connecting these elements to each other to transfer traffic from a local base station 3 to a local radio terminal 4 and vice versa. Each time, the radio links 2 are set up between a radio terminal 4 of a node 1 and a base station 3 of another node 1. The network shown also comprises individual radio terminals 6 connected to the network through two-directional radio links 7 with base stations 3 of nodes 1. The network can thus set up communications between two nodes 1, between a node 1 and an individual radio terminal 6, and between two individual radio terminals 6 connected to the same base station 3 or to different base stations.

Any point to multipoint radio technology can be used. Characteristics to be taken into consideration for the choice of a point to multipoint radio technology are particularly the range of links, whether or not there is an intercell transfer procedure to support the relative mobility between radio terminals and base stations, and whether or not there is a procedure for reservation of resources to support service quality management.

Another requirement that must be respected is to achieve an orthogonality condition between equipment collocated at a node. In particular, signals emitted by the node base station(s) must not hinder communications of the radio terminal(s) of the node with base stations of other nodes. Conversely, up communications from radio terminals of the node must not dazzle collocated base station(s). This is why OFDM type technologies will be preferred.

According to one preferred embodiment, the base stations 3 and the radio terminals 4 and 6 operate according to standard IEEE 802.16e, which gives a range typical of a metropolitan network type radio, service quality management means and intercell transfer management means. Up and down links between a base station 3 and radio terminals 4 and/or 6 attached to it are duplexed in time (TDD method). Access to air medium is shared between these radio terminals using an OFDMA method, which provides a fine and dynamic method of managing the pass band allocated to each terminal.

Any switch technique may be used in the nodes 1. Preferably, an Ethernet/IP protocol stack is used, particularly with the mobile IP protocol for radio terminals.

According to one particular embodiment shown in FIG. 2, an 802.16e compatible base station 3 comprises one or several antennas 31 that may be sectorial or omnidirectional or other, a radio front end unit 32, a base band processing module in the up direction 33 including an analogue/digital converter, a base band processing module in the down direction 34 including a digital/analogue converter, an access control module to support (MAC) in the up direction 35, an access control module to the support (MAC) in the down direction 36, a synchronisation module 37, an IP processing module 38 for multiplexing/demultiplexing IP packets, and an Ethernet interface 39 for connection to the LAN of the node. The processing modules in base band make tasks such as coding/decoding, encryption/decryption, processing of OFDM symbols, formation/beam analysis, etc.

According to one particular embodiment shown in FIG. 3, an 802.16e compatible radio terminal 4 comprises one or several antennas 41 that may be sectorial or omnidirectional or other, a radio front unit 42, a base band processing module 43, an IP interface 44 for connection to the LAN of the node, and a control unit 45 with a memory 46 and/or other storage means. According to one particular arrangement, a radio terminal 4 can be made from a microcomputer provided with an Ethernet interface and a WIMAX interface (PCI/PCMCIA). According to another particular embodiment, a radio terminal 4 is essentially composed of a radio modem with a microcontroller to control the attachment procedure.

According to one particular embodiment, a node comprises several radio terminals, for example 5 or more. In this case, some functions can be made in an integrated manner for several terminals, for example with a central digital signal processing unit shared by all terminals.

According to one particular embodiment shown in FIG. 4, a node 1 comprises the local base station(s) 3 and the local radio terminal(s) 4, and also a switch/router 10, an authentication/authorisation server 11, an address server 12, for example of the DHCP or other type, and a node control unit 13 to manage connectivity of the node. This description is concentrated on point to multipoint interfaces of the nodes 1 and links supported by these interfaces. However, the node 1 may also comprise other interfaces (not shown) connected to the local network 5, for example a radio interface to a satellite network or a gateway to an external wire network.

According to one preferred embodiment, a radio link 2 or 7 between a base station 3 and a radio terminal 4 or 6 is set up using a radio attachment procedure shown diagrammatically in FIG. 5. In FIG. 5, the reference numbers 3, 10, 11 and 12 denote elements belonging to the same node 1 and communicating through the local network 5. Communications between the base station 3 and the radio terminal 4 or 6 pass on the air interface.

The base station 3 periodically emits a beacon signal 20 on a predetermined channel or a predetermined set of channels so as to be detectable by adjacent radio terminals, at least by terminals compatible with the physical layer technology used.

Either repeatedly or continuously, the radio terminal 4 or 6 scans a portion of the electromagnetic spectrum so as to detect beacon signals from adjacent base stations. For example, the terminal scans a set of authorised frequencies defined by a data block 47 that is stored in the memory 46. When it detects a beacon signal 20, the radio terminal 4 or 6 replies by an attachment request 21, for example sent on the same frequency as the beacon signal. This phase, called the synchronisation phase 22, is used to negotiate layer parameters 1 and 2 of the link to be set up, for example the frequencies used. As a variant, several exchanges not shown may take place during this phase.

The next phase is an authentication and authorisation phase 23 during which the radio terminal and the authentication/authorisation server 11 authenticate each other, for example using an EAP (Extensible Authentication Protocol) or other protocol. The server 11 uses an identifier communicated by the radio terminal, to check if the radio terminal is authorised to connect to node 1. If it is, the server 11 transmits an authorisation message to the radio terminal and encryption keys to secure the sequence of exchanges. If not, the server 11 transmits an authentication refusal message to the radio terminal that terminates the attachment procedure.

The next phase is an entry phase into the network 24 during which the base station 3 records the newly connected radio terminal and creates a context to manage it.

The next phase is an IP configuration phase 25, during which the radio terminal sends a request to the address server 12 and receives an IP address in return for its radio interface.

The next phase is a service creation phase during which a signalling module of the router 10 sends signalling messages to reserve resources at the base station 3 and at the radio terminal for some flows, to achieve predefined service quality levels.

According to one particular embodiment, a radio terminal 4 or 6 sets up a radio link with a single base station at a time. After entering the network, it continues to scan the electromagnetic spectrum to detect updated adjacent base stations. The control units 13 of nodes 1 manage intercell transfer procedures to enable mobility of a radio terminal from one cell to another.

Other attachment procedures with different degrees of complexity can be used between the base stations and radio terminals. In particular, an authentication phase with an authentication server is an optional means of securing access to the network. Furthermore, those skilled in the art know other ways of securing the network if it is necessary. Similarly, an address configuration phase using an address server is an optional means of allocating addresses dynamically. Furthermore, those skilled in the art know other ways of allocating addresses. Consequently, depending on the embodiment, the communication node does not necessarily comprise all elements indicated in FIG. 4, it may also comprise other elements, for example a home agent to use the mobile IP protocol.

The use of an automated procedure based on detection of base stations by radio terminals makes it easy to deploy and redeploy a radio network comprising a plurality of nodes 1. However, it could be possible for a radio terminal 4 to attach itself to a base station 3 on the same node 1, which would reduce the connectivity of the node and create a useless connection, due to its redundancy with the local network 5.

According to a first preferred embodiment, nodes 1 use a method for management of radio links in which the radio terminal 4 or each radio terminal 4 of a node 1 does not monitor the part of the spectrum in which the or each base station of the same node emits beacon signals, to avoid this self attachment situation. To achieve this, data 47 in the memory 46 are systematically configured to exclude frequencies allocated to the or each local base station 3 of the node. This makes it impossible to set up an attachment between a radio terminal 4 and a base station 3 of the same node. In one embodiment that will be described later, frequencies are allocated to base stations 3 dynamically through remotely transmitted configuration messages. In this case, the control unit 13 may be made to update the data 47 in the memory 46 as a function of received configuration messages.

In one alternative embodiment, nodes 1 use a method for management of radio links shown in FIG. 6, to prevent a self-attachment situation. The logical, hardware and/or software means to execute this method may be arranged at control units 13 or base stations 3 or radio terminals 4, or they may be distributed between several of these elements.

In step 50, an adjacency situation between a radio terminal 4 and a base station 3 is detected. In step 51, a self-attachment condition is tested. This condition is true if radio terminal 4 and the base station 3 belong to the same node 1, and is false otherwise. If the condition is false, the attachment procedure is continued normally in step 52. If the condition is true, the attachment procedure is interrupted in step 53, such that the radio terminal cannot attach itself to the base station.

This method can be used in different ways. According to a first example, the step 50 is done by the radio terminal 4 receiving the beacon signal 20 from the base station 3. The beacon signal 20 contains a BSID identifier of the base station. A table 54 of local base stations of the node is preconfigured in a memory 17 of the control unit 13 or in the memory 46 of the radio terminal 4. Step 51 is done by the control unit 13 or the radio terminal 4, by comparing the BSID identifier of the detected base station with the content of the table 54. If the BSID identifier is in table 54, the radio terminal performs step 53 by omitting to send the request 21. If the BSID identifier is not in table 54, the radio terminal performs step 52 by sending the request 21.

According to a second example, step 50 is performed by the base station 3 receiving the attachment request 21 from the radio terminal 4. The request 21 contains a SSID identifier of the radio terminal 4. A table of local radio terminals 55 is preconfigured in a memory 17 of the control unit 13 or in the base station 3. The step 51 is done by the control unit 13 or the base station 3 by comparing the SSID identifier of the detected radio terminal with the content of the table 55. If the SSID identifier is in table 55, step 53 is done by the base station, by refusing following messages from the radio terminal or sending a rejection message to the radio terminal. If the SSID identifier is not in the table 55, the base station performs the step 52 continuing the attachment procedure.

In the above examples, step 51 takes place during the synchronisation phase 22. As a variant, step 51 can be done by the authentication/authorisation server 11 during phase 23, starting from authorisation data preconfigured in the server 11 and performing the same function as the above-mentioned tables 54 and 55. The server 11 interrupts the attachment procedure by sending an authentication refusal message. Other embodiments can be based on other data used to identify radio terminals and base stations, for example on IP addresses.

A telecommunication node 1 comprises at least a base station 3 and a radio terminal 4. A node with greater connectivity may be obtained by providing several local radio terminals and/or several local base stations. However, it is possible that these radio terminals and/or base stations generate redundant links with other nodes, which can increase the node transfer capacity but not its connectivity.

According to preferred embodiments, this situation can be avoided by the nodes 1 using a method for management of radio links shown in FIG. 7. The logical, hardware and/or software means to execute this procedure may be arranged at the control units 13 or base stations 3 or radio terminals 4, or they can be distributed between several of these elements.

In step 60, an adjacency situation is detected between a local radio terminal 4 of a first node and a local base station 3 of a second node. A redundancy condition is tested in step 61. This condition is true if there is already a radio link set up between a local radio terminal of the first node and a local base station of the second node, and is otherwise false. If the condition is false, the attachment procedure is continued normally in step 62. If the condition is true, the attachment procedure is interrupted in step 63, such that the radio terminal 4 cannot attach itself to the base station 3.

This method may be set up in many different ways. In a first example, in the case of a node 1 with several local radio terminals, step 60 is done by a radio terminal 4 receiving the beacon signal 20 from the base station 3. The beacon signal 20 contains a base station identifier BSID. A table 64 of the base station(s) to which the other local radio terminal(s) of the node are attached is kept up to date in the memory 17 of the control unit 13. Step 61 is carried out by the control unit 13 by comparing the detected base station identifier BSID with the content of the table 64. If the BSID identifier is in table 64, the radio terminal performs step 63 but does not send the request 21. If the BSID identifier is not in table 64, the radio terminal performs step 62 by sending the request 21. According to one variant, the control unit 13 also has a node recognition table not shown, to recognise that several base stations belong to the same node and also to prevent redundant links from being set up through different base stations.

According to a second example, in the case of a node 1 comprising several local base stations, step 60 is done by a local base station 3 receiving the attachment request 21 from the radio terminal 4. The request 21 contains an SSID identifier of the radio terminal 4. A table 65 of the radio terminal(s) that are attached to the other base station(s) of the node is kept up to date in the memory 17 of the control unit 13. The control unit 13 performs step 61 by comparing the SSID identifier of the detected radio terminal with the content of table 65. If the SSID identifier is in table 65, the base station performs step 63 by refusing subsequent messages from the radio terminal or by sending a rejection message to the radio terminal. If the SSID identifier is not in table 65, step 62 is performed by the base station, continuing the attachment procedure. According to one variant, the control unit 13 also has a node recognition table, not shown, used to recognise that several radio terminals belong to the same node and thus prevent redundant links from being set up through different radio terminals.

According to one particular embodiment of the management method, step 63 continues through a detection step 66 in which the radio terminal 4 searches to see if there is another adjacent base station to which it can attach itself. If no other base station is detected, the interrupted attachment procedure is resumed in step 62.

One essential phase in the deployment of a cellular network is to decide upon and to apply sharing of air medium between the different base stations. This phase is called frequency planning in the case in which this sharing is based on frequency bands allocated to base stations. Other sharing methods exist.

It may be desirable to manage this sharing dynamically, so as to produce a network that can be quickly reconfigured and/or that comprises mobile nodes. To achieve this, in one particular embodiment shown in FIG. 8, the telecommunication node 1 also comprises a low speed long range radio terminal 16 that receives configuration data from a network management system provided with an appropriate transmitter. Long range refers to a range that is at least greater than the average range of a point to multipoint link between a radio terminal 4 and a base station 3, and preferably a range greater than the diameter of the radio network formed by the nodes 1, such that each node can be configured from the same location. Low speed means a passband less than the average passband of a point to multipoint link between a radio terminal 4 and a base station 3. In some embodiments, the transfer of configuration data between a network management system and nodes 1 can be easily satisfied by known radio systems, for example VHF type radios using reserved frequencies, with a speed of the order of 10 kb/s or less.

FIG. 9 diagrammatically shows an example of the use of node 1 in FIG. 8 to form an ad hoc radio network. In this example, the nodes 1 are installed on ships 70 and are used to build a communication network covering an entire fleet. The network management system 15 is represented as being installed on a ship 70. It may also be colocated with one or several nodes 1. After a set of nodes 1 has been assembled in a geographic area, the network management system 15 transmits the air medium resource(s) allocated to its local base station(s) 3, to each node 1 on a predefined channel. The control unit 13 receives these data through the radio terminal 16 and configures the base station 3 as a function of these data, so as to respect allocated resources. In the example shown in FIGS. 9 and 10, air medium is shared between base stations by a frequency sharing. The management system 15 shares an authorised spectrum 71 into several frequency bands, in this case f1, f2 and f3, allocates a frequency band to each base station and transmits the corresponding configuration data to nodes 1. If the available number of frequency bands is less than the number of base stations, techniques for reuse of frequencies may be used taking account of the geographic position of base stations. It may also be decided to activate only some of the base stations. To achieve this, the management system 15 is preferably capable of remote control over activation/deactivation of base stations by transmission of the corresponding configuration data on a predefined management channel.

Once the base stations have received their corresponding frequency bands and have been activated, procedures for attachment with radio terminals can be executed. Thus, a radio network covering an entire fleet of ships or other vehicles can be obtained quickly. A meshed or partially meshed topology or other can be obtained, depending on the arrangement of nodes and the number of radio terminals provided. Globally, a high degree of connectivity of nodes 1 improves network resilience faced with events such as the disappearance of a link 2 or a node 1. The mobility of nodes among each other can be managed by control units 13 of nodes according to known hand-over procedures.

As mentioned above, in some embodiments, communication nodes 1 are capable of executing radio link management procedures preventing redundant links from being set up. Such capacities are useful in many situations, but are not essential in all cases or in all nodes. According to one preferred embodiment, a communication node 1 provided with such radio link management capacities can be controlled from the management system 15 to activate or deactivate these procedures selectively depending on whether or not it is required for this node to set up redundant links with an adjacent node. It may be required to enable or to force setting up several parallel radio links between two nodes to increase the data flow.

As an illustration, in an 802.16e type network, the width of the bands or channels used by base stations are 1.75 to 20 MHz. A base station with 3.5 MHz band can offer up to about 25 Mb/s depending on propagation conditions of the support and the separation distance between radio terminals. Under current usage conditions, the maximum separation distance is about 15 to 40 km depending on the antenna systems used. For illustration, an authorised spectrum according to regulations covering 20 MHz may be shared in six 3.5 MHz bands.

A network like that shown in FIG. 9 may include one or several management systems. A management system may also perform functions other than the configuration of base stations. According to one particular embodiment, the management system 15 is used to impose or to constrain the selection of a base station 3 by a radio terminal 4 in the network. To achieve this, the management system 15 transmits configuration data intended to configure a radio terminal of a node 1 on a predefined management channel, so as to oblige the terminal to attach itself to a predetermined base station when radio adjacency exists, or to impose selection rules that can be used by the radio terminal when it has to choose between several adjacent base stations. For example, one way in which the management system 15 can designate the base stations concerned is to communicate the frequencies that these base stations are using to emit beacon signals, to the radio terminal. Thus, configuration data received by the node 1 are used to modify all authorised frequencies defined by the data block 47, or to define prohibited frequencies, or to create a preferred hierarchical order between different frequencies. Such a radio terminal configuration function may for example be used to force a direct radio link to be set up between two determined nodes.

Other methods can also be used to dynamically assign frequencies to base stations, particularly automatic techniques known as Dynamic Frequency Selection (DFS).

As indicated, the radio network in FIG. 1 or 9 can be made using different communication protocols. With reference to FIGS. 11 and 12, we will now describe an IP configuration method that can be used in a radio network according to the invention. In FIG. 11, elements identical to or similar to those in FIG. 4 are designated by the same reference numbers plus 100 and 200. FIG. 11 shows two telecommunication nodes 100 and 200 connected through radio links 102 and 202. Furthermore, in this case the radio terminals 104 and 204 comprise a corresponding router 114 and 214.

According to this embodiment, a batch of IP addresses is allocated to each node. For example, a prefix P1 is allocated to node 100, based on which an IP address is formed for the base station 103 and an IP address is formed for the interface 80 of the or each radio terminal 104 connected to the local network 105. The remaining addresses may be allocated to remote radio terminals when they are attached to the base station 103, as will be explained later. For example, the radio terminal 204 receives an IP address for its radio interface 81 from the base station 103 as shown in FIG. 12. Thus, node 100 forms part of a first addressing space with prefix P1. Similarly, node 200 forms part of a second addressing space with prefix P2.

In FIG. 12, steps identical to or similar to those in FIG. 5 are designated by the same reference numbers plus 100. In step 125, after a successful synchronisation phase 122 and an authentication/authorisation phase 123, the radio terminal 204 sends an address request 85 to the address server 112, for example a DHCP request to a DHCP server. In response, the server 112 chooses an IP address from among the batch allocated to node 100 and sends it to the radio terminal 204. For example, the address is formed based on prefix P1 and will be denoted “@P1:204”. In the same way as for terminal 104, the radio terminal 204 has an IP address chosen from among the batch allocated to node 200, namely with prefix P2, to denote its interface 80 connected to the local network 205.

Subsequently, having received an IP address for the radio interface 81 of the radio terminal 204, the router 214 distributes the address of the network to which the base station 103 connects the router. Any IGP routing protocol can be used for this purpose, for example RIP, OSPF, IS-IS, etc. A routing protocol for an ad hoc network is advantageously used, for example the OLSR protocol to facilitate reconfiguration of the network and convergence of routing tables during events such as the addition or withdrawal of a node. Once the stationary state has been reached, routers 114 and 214 of the radio terminals and routers 110 and 210 have complete routing tables.

The method described above automates the IP configuration of the network and may be used on topologies other than that shown in FIG. 11.

According to one preferred embodiment, the routing table 91 of the router 110 is configured to reach the network of node 200 through the base station 103. To achieve this, the router 214 of the terminal 204 announces a route with destination to the network with prefix P2, passing through its radio interface 81; to the network 105. Thus, the routing table 91 records this route as shown in FIG. 11. Conversely, the routing table 92 of the router 210 may be configured to reach the network of node 100 through the base station 203. This embodiment gives priority to the use of down links from a base station to a radio terminal, rather than up links from a radio terminal to a base station, so as to benefit from a higher speed. This embodiment can be used in any topology in which there are at least two possible routes from a first node to a second node, one passing through an up link and the other passing through a down link.

Some of the elements shown, and particularly control units, servers and other modules, may be made in different forms, either unit or distributed, using hardware and/or software components. Hardware components used are application specific integrated circuits ASIC, programmable logical networks FPGA or microprocessors. Software components may be written in different programming languages, for example C, C++, Java or VHDL. This list is not exhaustive.

A network management system may be hardware equipment, for example a microcomputer, a workstation, a device connected to the Internet or any other dedicated or general-purpose communication device. Software programs run on this system perform network management functions to control network elements.

Although the invention has been described in relation to several particular embodiments, it is quite obvious that it is in no way limited and that it includes all technical equivalents of the means described and combinations of them if they enter the framework of the invention.

Use of the verbs <<comprise >>, <<contain >> or <<include >> and conjugated forms of them does not exclude the presence of elements or steps other than those mentioned in a claim. The use of the indefinite article <<a >> or <<an >> for an element or a step does not exclude the presence of a plurality of such elements or steps, unless mentioned otherwise. Several means or modules can be represented by a single hardware element.

Any reference symbol shown between parentheses in the claims shall not be interpreted as being a limitation of the claim.

1. Telecommunication node (1), characterised by the fact that it comprises at least one local base station (3) that can use a multiplexing method to set up point to multipoint radio links with radio terminals, at least one local radio terminal (4) capable of using said multiplexing method to set up a radio link with a base station, and a switch (10) to transfer data between said local radio terminal and said local base station, the local base station being capable of emitting beacon signals (20) to be detected by adjacent radio terminals, the local radio terminal comprising means of detecting beacon signals to detect a base station adjacent to said local radio terminal, and said communication node comprising radio link management means (13, 45) to inhibit setting up of redundant radio links involving said at least local radio terminal and/or said at least local base station.

2. Telecommunication node according to claim 1, characterised by the fact that radio link management means (47, 54, 55) are capable of inhibiting setting up a radio link between said or each local radio terminal and said or each local base station.

3. Telecommunication node according to claim 1, characterised by the fact that it comprises a plurality of local radio terminals, said radio link management means (64) being capable of detecting that a radio link is set up between a first of said local radio terminals and a base station and of inhibiting setting up of a radio link between a second of said local radio terminals and said base station in response to said detection.

4. Telecommunication node according to claim 1, characterised by the fact that said radio link management means (65) are capable of detecting that a radio link is set up between said local base station and a first radio terminal of a remote node and inhibiting setting up of a radio link between said local base station and a second radio terminal of said remote node in response to said detection.

5. Telecommunication node according to claim 1, characterised by the fact that it comprises a plurality of local base stations, said radio link management means being capable of detecting that a radio link is set up between a first of said local base stations and a remote node and inhibiting setting up of a radio link between a second of said local base stations and said remote node in response to said detection.

6. Telecommunication node according to claim 1, characterised by the fact that said or each local base station is capable of reserving and allocating air medium resources to determined communications.

7. Telecommunication node according to claim 1, characterised by the fact that the multiplexing method is of the OFDMA type.

8. Telecommunication node according to claim 1, characterised by the fact that it comprises a radio receiver (16) to receive configuration data defining air medium resources to be allocated to a local base station on a predefined low speed radio channel, and a configuration module (13) to configure said local base station so as to respect said allocated air medium resources.

9. Telecommunication node according to claim 1, characterised by the fact that it comprises a radio receiver (16) to receive configuration data defining an activity state of a local base station on a low speed radio channel, and a configuration module (13) to enable or disable said local base station as a function of said configuration data.

10. Telecommunication node according to claim 1, characterised by the fact that it is installed on a vehicle (70).

11. Telecommunication node according to claim 2, characterised by the fact that the radio link management means (47) are capable of configuring the detection means (42) of a local radio terminal (4) such that said detection means monitor part of the spectrum excluding one or each frequency on which a local base station (3) emits beacon signals (20).

12. Radio network comprising a plurality of telecommunication nodes according to claim 8, characterised by the fact that it comprises a management system (15) to define sharing of air medium resources between base stations of said telecommunication nodes, and a radio transmitter capable of transmitting configuration data on said low speed radio channel defining air medium resources to be allocated to each of said base stations, as a function of said sharing.

13. Method for management of radio links in a radio telecommunication network comprising steps consisting of:
emitting beacon signals from a base station,
detecting beacon signals at a radio terminal,
determining if the radio terminal and the base station belong to the same node in said network,
and inhibiting setting up of a radio link between the radio terminal and the base station when they belong to the same node of said network.

14. Method of configuring a telecommunication node, comprising steps consisting of:
deploying at least one radio telecommunication node comprising at least one local base station that can use a multiplexing method to set up point to multipoint radio links with radio terminals, at least one local radio terminal capable of using said multiplexing method to set up a radio link with a base station, and a switch to transfer data between said local radio terminal and said local base station,
transmitting configuration data defining air medium resources to be allocated to said local base station, on at least one low speed long range radio channel,
receiving said configuration data at said telecommunication node and configuring said local base station so as to respect said allocated air medium resources.

15. Method of configuring a telecommunication node, comprising steps consisting of:
deploying at least one radio telecommunication node (1) comprising at least one local base station (3) capable of using a multiplexing method to set up point to multipoint radio links with radio terminals, at least one local radio terminal (4) capable of using said multiplexing method to set a radio link with a base station, and a switch to transfer data between said local radio terminal and said local base station,
transmitting configuration data on a low speed long range radio channel, defining a channel allocated to a base station,
receiving said configuration data at said telecommunication node and configuring a said local radio terminal (4) so that it monitors said defined channel to detect beacon signals.
